(19) United States
(12) Patent Application Publication
(10) Pub. No.: US 2016/0117028 A1
(43) Pub. Date: Apr. 28, 2016

(54) WIRING FILM FOR TOUCH PANEL SENSORS, AND TOUCH PANEL SENSOR

(71) Applicant: KABUSHIKI KAISHA KOBE SEIKO SHO (KOBE STEEL, LTD.), Hyogo (JP)

(72) Inventors: Yoko SHIDA, Kobe-shi (JP); Hiroshi GOTO, Kobe-shi (JP); MOTOTAKA OCHI, Kobe-shi (JP)

(73) Assignee: KABUSHIKI KAISHA KOBE SEIKO SHO (KOBE STEEL, LTD.), Kobe-shi (JP)

(21) Appl. No.: 14/888,816

(22) PCT Filed: May 26, 2014
(86) PCT No.: PCT/JP14/63891

§ 371 Date: Nov. 3, 2015

(30) Foreign Application Priority Data
Jun. 5, 2013 (JP) 2013-119311

(51) Int. Cl. G06F 3/047; G06F 3/045; B32B 15/01

(52) U.S. Cl. CPC G06F 3/047; B32B 15/017; G06F 3/045

(57) ABSTRACT

This interconnection film for touch panel sensors is configured of a laminate structure that is composed of a first layer which is formed on a transparent conductive film and is comprising pure Cu or a Cu alloy that is mainly composed of Cu, and a second layer which is formed on the first layer and is formed of pure Al or an Al alloy that contains at least one element selected from a group consisting of Ta, Nd and Ti in an amount of 10 atomic % or smaller.

### TECHNICAL FIELD

The present invention is related to; an interconnection film wired to a transparent conductive film to be used in a touch panel sensor; and a touch panel sensor.

### BACKGROUND ART

A touch panel sensor comprises in general a transparent electrode formed on an input region, and an interconnection part disposed on a side portion of the input region (non-input region) and electrically-wired to the transparent conductive electrode (see for example Patent document 1). The interconnection part is mainly composed of an interconnection film composed of a metal material such as Cu, Al, and Ag formed on a transparent conductive film constituting the transparent electrode. Generally used for the interconnection film is Cu having particularly low electrical resistance.

### DESCRIPTION OF THE RELATED ART

### Patent Document

Patent Document 1; Japanese Patent Laid-open Publication No. 2012-43298

### SUMMARY OF THE INVENTION

### Problems to be Solved by the Invention

In the course of manufacturing process of touch panel sensors, a heat treatment is conducted in general at low temperatures less than 200° C. There is also a case in which a heat treatment is performed at temperatures at 200° C. or higher (for example at about 230° C.) in an air atmosphere. When a Cu interconnection material is subjected to a heat treatment at such a relatively high temperature in an air atmosphere, a semitransparent dark brown Cu oxide is easily formed on the surface by a reaction of Cu with oxygen, resulting in change in color of the interconnection film. Defects in interconnection materials are usually detected by an optical method. When color of an interconnection film is changed as described, it is detected as a defect, causing deterioration of the production yield.

The present invention has been made under the circumstances described above, and an object of the present invention is to provide a Cu interconnection film wired to a transparent conductive film to be used in a touch panel sensor; and a touch pane sensor using such a novel interconnection film. The interconnection film not only has a low electrical resistance but also has a surface which does not change in terms of color even if it is subjected to a heat treatment at about 200° C. or higher in an air atmosphere.

### Means for Solving the Problems

The interconnection film for a touch panel sensor according to the present invention that was capable of solving the problem is formed on a transparent conductive film. The interconnection film wired to a transparent conductive film to be used in a touch panel sensor is constituted of a laminate structure comprising a first layer pure Cu or a Cu alloy that is mainly composed of Cu, and a second layer which is formed on the first layer and composed of pure Al or an Al alloy that contains at least one element selected from a group consisting of Ta, Nd and Ti in an amount of 10 atomic % or smaller.

In a preferred embodiment of the present invention, the second layer comprises an Al alloy containing one or more kinds of element selected from a group consisting Ta, Nd, and Ti in a range of 10 atomic % or lower.

In a preferred embodiment of the present invention, the Cu alloy constituting the first layer comprises one or more kinds of element selected from a group consisting Ni, Zn, and Mn.

A touch panel sensor comprising any of the interconnection films described hereinabove is also included in the present invention.

### Effects of the Invention

The interconnection films for a touch panel sensor according to the present invention comprises a laminate structure having a pure Al or a predetermined Al alloy formed on a Cu interconnection material of low electrical resistance. Change in color of the surface of the interconnection film can be avoided even when the film is subjected to a thermal history of 200° C. or higher in an air atmosphere while maintaining a low electrical resistance required for an interconnection film. Consequently, defects are not detected in the interconnection film by a generally-known optical method, and the production yield is improved.

According to the present invention, it has been made possible to provide a Cu alloy interconnection film for a touch panel sensor and a touch panel sensor having the interconnection film. Change in color of the surface of the interconnection film can be avoided even after a heat treatment at a relatively high temperature in an air atmosphere, which has not been employed in manufacturing touch panel sensors.

### BRIEF DESCRIPTION OF DRAWINGS

FIG. 1 is a schematic cross-sectional view illustrating a part of configuration of a touch panel sensor comprising the interconnection film according to the present invention.

FIG. 2 is a cross-sectional TEM picture of comparative example No. 3 in Table 1.

### MODE FOR CARRYING OUT THE INVENTION

The present inventors have made intensive studies in order to provide an interconnection film, directly wired to a transparent conductive film, to be used for a touch panel sensor. The novel interconnection film not only has a low electrical resistance by comprising a Cu film but is capable to avoid undergoing change in terms of color of the surface even when it is subjected to a heat treatment at about 200° C. or higher in an air atmosphere. As a result of the studies, the present inventors have found that the purpose was attained by an interconnection film of a laminate structure comprising a first layer pure Cu or a Cu alloy that was mainly composed of Cu, and a second layer which was formed on the first layer and composed of pure Al or an Al alloy that contained one or more kinds of element selected from a group consisting of Ta, Nd and Ti in an amount of 0.1 to 10 atomic %.

In the present specification, “a heat treatment at 200° C. or higher in an air atmosphere” represents that a heating temperature of about 200° C. to 300° C. and a heating time of about 30 minutes to 1 hour. The heat treatment is related to a thermal history after forming a first layer and a second layer.

Further in the present specification, “change in color of the surface of the Cu interconnection film can be avoided even after being subjected to a thermal history at 200° C. or higher in an air atmosphere” represents a case in which a variation rate of reflectance is 50% or smaller when an interconnection film is subjected to a heat treatment at 230° C. for 1 hour in an air atmosphere and the reflectance is measured before and after the heat treatment.

In the present specification, “a low electrical resistance” represents that measured electrical resistance of 200 mΩ/□ or smaller which was obtained for the interconnection film of a laminate structure comprising a first layer and a second layer before the heat treatment according to a method described in an example below.

Pure Al or an Al alloy that contains one or more kinds of element selected from a group consisting of Ta, Nd and Ti, which composes a second layer, is occasionally referred to as “pure Al or a predetermined Al alloy” occasionally.

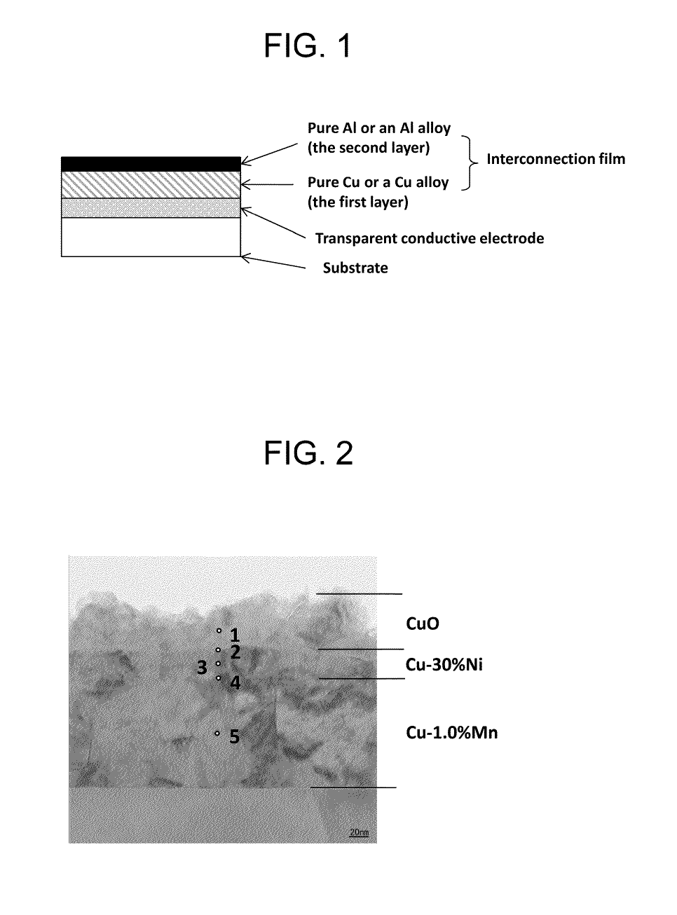

A touch panel sensor comprising the interconnection film according to the present invention is described in detail hereinbelow by referring to FIG. 1.

The touch pane sensor according to the present invention comprises a substrate, a transparent conductive film formed on the substrate, and an interconnection film directly wired to the transparent conductive film as illustrated in FIG. 1. The interconnection film is composed of a laminate structure comprising the first layer directly formed on the transparent conductive film and the second layer directly formed on the first layer. The first layer is composed of pure Cu or a Cu alloy that is mainly composed of Cu, and contributes to decreasing electrical resistance. The second layer is composed of pure Al or an Al alloy that contains one or more kinds of element selected from a group consisting of Ta, Nd and Ti in an amount of 10 atomic % or smaller (pure Al or a predetermined Al alloy). The second layer contributes to avoiding change in color of the surface of the interconnection film when it is subjected to a thermal history at 200° C. or higher in an air atmosphere

Firstly, the interconnection film of the present invention is described in detail.

(Regarding Pure Cu or a Cu Alloy Constituting the First Layer)

The first layer directly formed on the transparent conductive film is composed of pure Cu or a Cu alloy that is mainly composed of Cu. Specifically, the Cu alloy is not particularly limited as long as low electrical resistance inherent to Cu interconnection material is secured. For example, conventionally used materials may be used.

In the present specification, the first layer having a low electrical resistance is represented by electrical resistivity of 11 μΩ-cm or smaller, from the point of view to suppressing signal delay and power loss caused by electrical resistance of an interconnection in a touch panel sensor. The electrical resistance of the first layer is preferably 8.0 μΩ-cm or smaller, and more preferably 5.0 μΩ-cm or smaller.

The present invention may employ a Cu alloy in which at least either the kind or the contained amount of an alloy element is appropriately controlled so that the electrical resistivity satisfies the specified range.

An element having a low electrical resistivity (preferably an element having electrical resistivity as low as that of pure Cu) to be used for the Cu alloy may be easily selected from generally-known elements by referring to values in literatures or the like. Preferably contained amount may be appropriately adjusted according to kind of element to be used so that the electrical resistivity is within the specified range.

Alternatively, an element having a high electrical resistivity may be used for the Cu alloy. In such a case, contained amount of the element is suppressed low so that the electrical resistivity is within the specified range. Specifically, it is possible to suppress the electrical resistivity by decreasing the amount to about 0.05 to 1 atomic % depending on kind of the employed element.

For example, Cu—Ni alloy, Cu—Zn alloy, Cu—Mn alloy, Cu—Mg alloy, and Cu—Ca alloy; and a Cu alloy containing one or more kinds of the alloying element are preferably used in the present invention. Among them, Cu—Ni alloy, Cu—Zn alloy, and Cu—Mn alloy have relatively low electrical resistance. Upper limit of a content of the alloying elements (one or more kinds of Ni, Zn, and Mn) may be set to about 10 atomic % or smaller. The Cu alloys may contain a gas component such as oxygen gas and nitrogen gas. For example, Cu—O and Cu—N may be used, accordingly.

The Cu alloy comprises the applicable element and the remainder essentially being Cu and inevitable impurities.

A content of each of the alloy elements in the Cu alloy films of the present invention as well as in Al alloy films for the second layer described below may be determined by, for example, the ICP (inductively coupled plasma) emission spectrometry method.

Thickness of the first layer composed of pure Cu or a Cu alloy that is mainly composed of Cu is preferably 50 nm or larger. If the first layer is too thin, there may be a case in which the resistance of the interconnection is increased. The thickness is more preferably 70 nm or larger, and even more preferably 100 nm or larger. If the first layer is too thick, on the other hand, there may be a case in which the shape of the interconnection is deteriorated or etching residues are generated. The thickness is preferably 600 nm or smaller, more preferably 500 nm or smaller, and even more preferably 450 nm or smaller, accordingly.

(Regarding pure Al or a predetermined Al alloy composing the second layer) The interconnection film for a touch panel sensor according to the present invention is characterized in that the first layer composed of pure Cu or a Cu alloy is disposed directly on a second layer composed of pure Al or a predetermined Al alloy.

The surface of Cu composing the first layer is easily oxidized to form a Cu oxide upon being subjected to a high temperature heat treatment at about 200° C. or higher in the presence of oxygen such as an air atmosphere. It is thus necessary to form a protective layer which prevents the Cu from being oxidized. It is required for the protective layer to be highly resistive (to have high resistance) to oxidation. Further, if the protective layer having high resistance to oxidation is inferior in terms of the film quality such as surface roughness, then Cu elements would diffuse from the first layer via grain boundaries to the surface on which a Cu oxide is formed. The protective layer is required to be dense, accordingly. Pure Al or a predetermined Al alloy which is used as a protective layer in the present invention forms a passivation film on the surface. Because an Al passivation film is dense, the diffusion of Cu elements can be prevented. Therefore, by laminating the second layer of pure Al or a predetermined Al alloy as a protective layer on the first layer, change in color of Cu due to oxidation can be prevented.

Moreover, a predetermined Al alloy used instead of pure Al is significantly useful as it prevents problems such as aggregation and surface roughening by the heat treatment.

Ta, Nd, and Ti, which compose the Al alloy, are selected from the point of view based on numerous fundamental experiments. These elements have effects to suppressing thermal aggregation and refining crystal grains when the alloy is subjected to the high temperature thermal history. Surface smoothness of the film is thus maintained after being subjected to the thermal history. The decrease in reflectance due to the thermal history is suppressed, and change of the interconnection film in terms of the color is prevented, accordingly. Any one kind of these elements may be used. Alternatively two or more kinds of these elements may be used in combination. Among these elements, Ta and Nd are preferable.

The content of the element (when one of the elements is added, the content is based on the amount of the element contained; and when two of the elements are added, the content is based on the total amount of the elements) is preferably 0.1 atomic % or more. If the content of the element is less than 0.1 atomic %, the element may not effectively exert the effect to suppressing the aggregation by the heating. The content of the element is preferably 0.2 atomic % or larger. However, if the content of the element is too large, electrical resistance is increased. The upper limit is 10 atomic %, accordingly. The upper limit is preferably 3 atomic % or smaller, and more preferably 2 atomic % or smaller.

The Al alloy comprises one or more kinds of Ta, Nd, and Ti in the predetermined amount and the remainder essentially being Al and inevitable impurities.

Thickness of the second layer composed of pure Al or a predetermined Al alloy is preferably 5 nm or larger. When the thickness of the second layer is 5 nm or smaller, it is difficult to form the film on the surface in an uniform manner. The thickness is more preferably 10 nm or larger. When the thickness of the second layer is larger than 150 nm on the other hand, difference in terms of taper from a Cu interconnection material (the first layer) disposed underneath the second layer becomes significant, becoming liable to break the interconnection film. The thickness is more preferably 100 nm or smaller.

Total thickness of the entire interconnection film which is a laminate film having the first and second layers used for the present invention is preferably about 100 nm or larger, more preferably 200 nm or larger. The thickness is preferably 600 nm or smaller, and more preferably 450 nm or smaller.

Each of the films constituting the first and the second layers is preferably formed by a sputtering method. By adopting a sputtering method, a film having substantially the same composition as the sputtering target can be deposited. By using a sputtering target having the same composition as that of a desired Cu alloy or an Al alloy film, it is possible to obtain a desirable film having a small deviation in terms of composition. It is noted, however, that sputtering target to be used is not limited thereto. A sputtering target having a different composition may be used. Composition of deposited film may also be adjusted by chipping a metal of a desired alloying element on a pure Cu or a pure Al target.

Specifically, the first layer may be formed by a sputtering method, and then the second layer may be formed by a sputtering method on top of the first layer in order to manufacture the interconnection film having a laminate structure according to the present invention.

With respect to the sputtering method, any sputtering method such as a DC sputtering method, a RF sputtering method, a magnetron sputtering method, and a reactive sputtering method may be employed. The sputtering conditions may be appropriately set. With respect to the shape of the sputtering target, the target may be processed into any shape (a square plate-like shape, a circular plate-like shape, a doughnut plate-like shape, a cylinder shape, or the like) corresponding to the shape and the structure of a sputtering apparatus.

Explanation has been made on the interconnection film according to the present invention hereinabove.

The present invention is characterized in that chemical compositions of the interconnection film wiring to a transparent conductive electrode are specified as described above. Other configurations are not particularly limited. Generally-known configurations ordinary used in the field of touch panel sensors may be employed.

With respect to the substrate, a generally-used transparent substrate may be employed. Examples of such a substrate are a glass and a resin-base substrate such as polyethylene terephthalate, polycarbonate, or polyamide. A polyethylene terephthalate, polycarbonate, or polyamide based films is preferably used because of low material cost and compatibility to a roll-to-roll process. For example, a glass substrate and a polycarbonate-based film may be used for a fixed bottom electrode and a top electrode having flexibility, respectively, in the present invention. Regarding the thermal history to which a film substrate is subjected, there are few problems as long as the temperature is lower than or equal to the heat proof temperature of the film. From the point of view to improving adherence of the film, a film having a heat proof temperature of 100° C. or higher is preferably used.

A transparent conductive film disposed on a substrate is not particularly limited. Typical examples are indium tin oxide (ITO) and indium zinc oxide (IZO).

The touch panel sensor according to the present invention may be used in a resistive film type, an electrostatic capacitance type, an ultrasonic surface acoustic wave type, or the like. The touch panel sensor according to the present invention may be manufactured by a generally-known method.

### EXAMPLES

The present invention is described hereinafter more specifically by way of examples, but the present invention is not limited to the following examples. The present invention can be put into practice after appropriate modifications or variations within a range meeting the gist described above and below, all of which are included in the technical scope of the present invention.

### Example 1

### Fabrication of Samples No. 1 to 13

In the present example, various kinds of interconnection films were formed on an ITO film. Reflectance before and after the heat treatment and electrical resistance before the heat treatment were measured for each of the interconnection films as described in detail in the following. In Table 1, % represents atomic %, the remainder of respective Al alloy is Al and inevitable impurities, and the remainder of respective Cu alloy is Cu and inevitable impurities.

First, a transparent conductive film (ITO) of 100 nm in thickness was deposited by DC magnetron sputtering on a glass substrate (“EAGLE XG” available from Corning Inc, having a diameter of 100 mm and a thickness of 10.7 mm). The sputtering conditions were as follows.

“HSR-552S” manufactured by Shimadzu Corporation

Back pressure: 1.0×10⁻⁶ Torr or lower

Processing gas: Ar, 5 sccm; 5%—O₂/Ar, 8 sccm

Sputtering power: 1.85 W/cm²

Distance between the electrodes: 50 mm

Deposition temperature: room temperature

Substrate temperature: room temperature

Next, a first layer of pure Cu or a Cu alloy film was formed directly on top of the ITO film as indicated in Table 1, followed by formation of a second layer of a Cu alloy film, a pure Al film, or an Al alloy film (Nos. 2 to 13 in Table 1). For the deposition of each of the films, a sputtering target having a corresponding chemical composition was used. DC magnetron sputtering was employed for the sputtering. For the purpose of comparison, a sample without a second layer was also prepared as No. 1 in Table 1. Every film was deposited under the following sputtering condition.

“HMS-552” manufactured by Shimadzu Corporation

Back pressure: 1.0×10⁻⁶ Torr or lower

Processing gas pressure: 2 mTorr

Processing gas: Ar, 30 sccm

Sputtering power: 3.2 to 1.6 W/cm²

Distance between the electrodes: 50 mm

Deposition temperature: room temperature

Substrate temperature: room temperature

(Measurement of Reflectance Before and after Heat Treatment)

Reflectance of the respective sample was measured at a wavelength of 550 nm before and after a heat treatment at 230° C. for 1 hour in an air atmosphere. The reflectance was evaluated by measuring the absolute reflectivity using a spectrophotometer (V-570 spectrophotometer manufactured by JASCO Corp.). Difference of measured reflectance (change in reflectance) before and after the heat treatment was calculated for each of the samples. And a ratio of the change in reflectance to the reflectance before the heat treatment was computed as a variation rate (%). In the present example, samples having a variation rate thus determined of 50% or smaller were rated acceptable while those having a variation rate larger than 50% were rated unacceptable.

(Measurement of Electrical Resistance Before Heat Treatment)

Electrical resistance of the respective sample was measured by four-point probe method before the heat treatment. Sheet resistance was derived from the measured electrical resistance. Samples having a sheet resistance of 200 mΩ/□ or smaller were categorized as acceptable while those having a sheet resistance of larger than 200 mΩ/□ were categorized as unacceptable.

The results are summarized in Table 1. The rightmost column in Table 1 is for total judgment. When all of the criteria were satisfied, then the total judgment was rated acceptable. When any one of the criteria was not satisfied, then the total judgment was rated unacceptable.

(TEM Analyses)

A cross-section of No. 3 after the heat treatment was observed by using a field-emission transmission electron microscope (TEM) HF-2200 available from Hitachi, Ltd. The result is indicated in FIG. 2. For each of the points 1 to 5 in FIG. 2, chemical composition was analyzed by using an EDX analysis System SIX available from Noran Instruments. The results are summarized in Table 2.

TABLE 1

| | | | | | | | Electrical | |
|---|---|---|---|---|---|---|---|---|
| | | | Reflectance (550 nm) | | | Variation | resistance | |
| | Interconnection film | | Before heat | After heat | Change in | rate of | before heat | |
| | The second layer | The first layer | treatment | treatment | reflectance | reflectance | treatment | Total |
| No. | (film thickness) | (film thickness) | (%) | (%) | (%) | (%) | mΩ/□ | evaluation |
| 1 | none | pure Cu | 65.70 | 23.57 | 42.13 | 64.12 | 110.60 | unacceptable |
| | | (150 nm) | | | | | | |
| 2 | Cu—30% Ni | pure Cu | 62.54 | 5.50 | 57.04 | 91.21 | 147.97 | unacceptable |
| | (35 nm) | (150 nm) | | | | | | |
| 3 | Cu—30% Ni | Cu—1.0% Mn | 63.20 | 4.30 | 58.90 | 93.20 | 149.20 | unacceptable |
| | (35 nm) | (150 nm) | | | | | | |
| 4 | pure Al (35 nm) | pure Cu | 89.90 | 62.79 | 27.11 | 30.16 | 170.00 | acceptable |
| 5 | Al—0.28% Nd—0.16% | pure Cu | 72.95 | 63.76 | 9.19 | 12.60 | 116.00 | acceptable |
| | Ta (5 nm) | (150 nm) | | | | | | |
| 6 | Al—0.28% Nd—0.16% | pure Cu | 81.34 | 76.06 | 5.28 | 6.49 | 118.00 | acceptable |
| | Ta (10 nm) | (150 nm) | | | | | | |
| 7 | Al—0.28% Nd—0.16% | pure Cu | 86.70 | 63.30 | 23.40 | 26.99 | 120.00 | acceptable |
| | Ta (15 nm) | (150 nm) | | | | | | |
| 8 | Al—0.28% Nd—0.16% | pure Cu | 87.20 | 62.30 | 24.90 | 28.56 | 137.21 | acceptable |
| | Ta (20 nm) | (150 nm) | | | | | | |
| 9 | Al—0.28% Nd—0.16% | pure Cu | 89.57 | 63.24 | 26.33 | 29.40 | 138.92 | acceptable |
| | Ta (35 nm) | (150 nm) | | | | | | |
| 10 | Al—0.2% Nd | pure Cu | 90.60 | 64.54 | 26.06 | 28.76 | 162.00 | acceptable |
| | (35 nm) | (150 nm) | | | | | | |
| 11 | Al—2.0% Nd | pure Cu | 88.57 | 73.04 | 15.53 | 17.54 | 158.00 | acceptable |
| | (35 nm) | (150 nm) | | | | | | |
| 12 | Al—1.0% Ta | pure Cu | 90.91 | 75.45 | 15.46 | 17.00 | 147.00 | acceptable |
| | (35 nm) | (150 nm) | | | | | | |
| 13 | Al—6.0% Nd | pure Cu | 80.56 | 63.45 | 17.11 | 21.24 | 155.00 | acceptable |
| | (35 nm) | (150 nm) | | | | | | |

TABLE 2

| Point | O | Ni | Cu |
|---|---|---|---|
| 1 | 31.9 | 0.1 | 68 |
| 2 | 46.1 | 11 | 42.9 |
| 3 | 0 | 31.7 | 68.3 |
| 4 | 0 | 4.5 | 95.5 |
| 5 | 0 | 1.5 | 98.5 |

The results may be considered as follows.

Firstly, No. 1 was a conventional example in which a pure Cu was used for an interconnection film consisting of a single first layer. As No. 1 did not comprise a second layer according to the present invention, the reflectance was decreased and the transparency was increased due to oxidation of Cu upon being subjected to a heat treatment at high temperature in an air atmosphere. The variation rate of reflectance was as large as about 64%.

No. 2 was a comparative example in which a second layer composed of a Cu-30 atomic % Ni alloy was formed on No. 1 to obtain a laminate interconnection film. When the Cu-30 atomic % Ni alloy was used for a second layer, formation of Cu oxide in the course of the heat treatment in an air atmosphere was not avoided. The variation rate of reflectance was increased to about 90%.

No. 3 was a comparative example of a laminate interconnection film in which a Cu-1.0 atomic % Mn alloy was formed as the first layer instead of pure Cu in No. 2. The variation rate of reflectance was about 93% in No. 3, which was even larger than that of No. 2. From the results of No. 2 and No. 3, it was found impossible to suppress the formation of Cu oxide in the course of the high temperature heat treatment in an air atmosphere when Cu-30 atomic % Ni alloy was used for a second layer, regardless of the kind of the first layer.

The results of No. 3 may be confirmed by a TEM cross-sectional picture depicted in FIG. 2 and a compositional analysis in Table 2. As indicated as point 1 and point 2 in FIG. 2 and Table 2, an oxide film of CuO having a high content of oxygen (O) was formed on the surface of the second layer of Cu-30 atomic % Ni alloy when No. 3 was subjected to the high temperature heat treatment. As seen in Table 2, such a presence of oxygen was not observed in the first layer of Cu-1.0 atomic % Mn alloy (point 5 in FIG. 2), in the vicinity of interface between the first layer and the second layer of Cu-30 atomic % Ni alloy (point 4 in FIG. 2), or in the second layer (point 3 in FIG. 2). It was thus confirmed that the Cu-30 atomic % Ni alloy did not have an effect of suppressing or preventing formation of an oxide film of CuO in the course of the heat treatment in an air atmosphere.

With respect to the point No. 3, the amount of Ni was larger than 30 mass % in Table 2. The data was acquired at a local spot of several tens of nanometer in diameter and due to segregation. The mean value of the film was Cu-30 atomic % Ni.

On the other hand, Nos. 4 to 13 were inventive examples of laminate interconnection films having the predetermined second layer (pure Al or an Al alloy) of various thickness on the No. 1 film. In each of the samples, the variation rate of reflectance was decreased to 50% or smaller as indicated in Table 1. The electrical resistance was also sufficiently small before the heat treatment in all of the samples.

Although TEM pictures of Nos. 4 to 13 are not shown, it was confirmed in each of the samples that an oxide film of CuO was not formed on the surface of the second layer, which is different from the case shown in FIG. 2. It was thus confirmed that formation of Cu oxide in the course of the heat treatment in an air atmosphere may be suppressed while maintaining the low electrical resistance by using the laminate interconnection film according to the present invention.

The present application has been described in detail by referring to specific embodiment in the above. It is obvious for a person skilled in the art that various modifications and corrections can be made within the scope and the spirit of the present invention. The present application claims the benefit of priority based on Japanese Patent Application No. 2013-119311 filed on Jun. 5, 2013. The entire contents of the files are incorporated herein by reference.

### INDUSTRIAL APPLICABILITY

According to the present invention, the interconnection film for a touch panel sensor has a low electrical resistance. The surface does not change in terms of color even after a heat treatment at about 200° C. or higher in an air atmosphere. The production yield of a touch panel sensor is significantly improved.

1. An interconnection film wiring to a transparent conductive film in a touch panel sensor wherein the interconnection film is configured of a laminate structure comprising;
a first layer which is low in terms of electrical resistance and composed of pure Cu or a Cu alloy that is mainly composed of Cu, and
a second layer which is formed on the first layer and composed of pure Al or an Al alloy that contains one or more kinds of element selected from a group consisting of Ta, Nd and Ti in an amount of 10 atomic % or smaller.

2. The interconnection film for a touch panel sensor according to claim 1 wherein
the second layer comprises an Al alloy containing one or more kinds of element selected from a group consisting Ta, Nd, and Ti in an amount of 10 atomic % or smaller.

3. The interconnection film for a touch panel sensor according to claim 1 wherein
the Cu alloy composing the first layer comprises one or more kinds of element selected from a group consisting Ni, Zn, and Mn.

4. The interconnection film for a touch panel sensor according to claim 2 wherein
the Cu alloy composing the first layer comprises one or more kinds of element selected from a group consisting Ni, Zn, and Mn.

5. A touch panel sensor comprising the interconnection film according to claim 1.

6. A touch panel sensor comprising the interconnection film according to claim 2.

7. A touch panel sensor comprising the interconnection film according to claim 3.
